(19) United States
(12) Patent Application Publication
(10) Pub. No.: US 2015/0022437 A1
(43) Pub. Date: Jan. 22, 2015

(54) Body Mind Machine Interface and Method

(71) Applicant: Ramesh Rangiah, Pleasanton, CA (US)

(72) Inventor: Ramesh Rangiah, Pleasanton, CA (US)

(21) Appl. No.: 14/037,006

(22) Filed: Sep. 25, 2013

Related U.S. Application Data
(60) Provisional application No. 61/856,438, filed on Jul. 19, 2013.

(51) Int. Cl. G06F 3/01

(52) U.S. Cl. CPC G06F 3/015
USPC 345/156

(57) ABSTRACT

A body mind machine interface has a neural interface grid operably printed or implanted in or on the user, and a sensor pad for receiving conducted electrical currents from the neural interface grid and generating an electrical signal that is transmitted to an interface computer. The interface computer has a computer processor and a computer memory, and an interface program operably installed on the computer memory for processing the electrical signal from the sensor pad and determining a direction from the brain.

### CROSS-REFERENCE TO RELATED APPLICATIONS

This application for a utility patent claims the benefit of U.S. Provisional Application No. 61/856,438, filed Jul. 19, 2013.

### BACKGROUND OF THE INVENTION

1. Field of the Invention

This invention relates generally to mind-machine interfaces, and more particularly to a body mind machine interface that receives signals from the brain, via the nerve endings in the body, and determines an output in response to the signals via an interface computer.

2. Description of Related Art

There is a long-felt need in the marketplace for a system that is able to transmit direction directly from a brain of a person to a computer. The “direction” may include a specific instruction, a form of data, or a general emotional response or feeling. The “direction” may also include general or specific intentions from the user's brain, or also be one or more raw signals generated from the user's brain.

Prior art devices are able to direct specific instructions via the intermediary of physical movements (movements of a mouse, typing on a keyboard, movements of the eye, etc.). The prior art does not teach the direct communication of instructions via the brain of the user. The prior art also does not teach the direct communication of thought, data, and emotions.

### SUMMARY OF THE INVENTION

The present invention teaches certain benefits in construction and use which give rise to the objectives described below.

The present invention provides a body mind machine interface for receiving direction from a brain of a user. The body mind machine interface includes a neural interface grid operably printed or implanted in or on the user for conducting electrical currents. The interface also includes a sensor pad for receiving the conducted electrical currents from the neural interface grid, and generating an electrical signal that is transmitted to an interface computer. The interface computer has a computer processor and a computer memory, and an interface program operably installed on the computer memory for processing the electrical signal from the sensor pad and determining the direction from the brain.

A primary objective of the present invention is to provide a body mind machine interface having advantages not taught by the prior art.

Another objective is to provide a body mind machine interface that provides a communications link between a user's mind and/or body and an interface computer.

Another objective is to provide a body mind machine interface that utilizes information from the user's mind and/or body, to improve the health or well-being of the user.

Another objective is to provide a body mind machine interface that enables new modes of communication by the user in the form of emotional sensing and display by the body mind machine interface.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a user utilizing a body mind machine interface, illustrating a shirt and a glove that are adapted for use with the system;

FIG. 2 is a close up view of a first collection of neural interface grids imprinted on the user's arm;

FIG. 3 is a close up view of a second collection of the neural interface grids imprinted on the user's finger;

FIG. 4 is a cross-sectional view of one embodiment of the body mind machine interface, illustrating embedded sensors connected to sheathed wires for transmitting electrical signals;

FIG. 5 is a perspective view of one embodiment of the sheathed wires, illustrating an inner wire surrounded by an outer layer;

FIG. 6 is a front elevational view of the shirt of FIG. 1, with a portion of the shirt broken away to illustrate a sensor pad integrated into the shirt;

FIG. 7 is a front elevational view of the glove of FIG. 1, with portions of the glove broken away to illustrate another embodiment of the sensor pad integrated into the glove; and

FIG. 8 is a block diagram of the body mind machine interface.

### DETAILED DESCRIPTION OF THE INVENTION

The above-described drawing figures illustrate the invention, a body mind machine interface 10 for allowing direct two-way communication between a brain 12 of a user and an interface computer 34. The body mind machine interface 10 interfaces with neural interface grids 20 that are printed or otherwise implanted on the user, as described below.

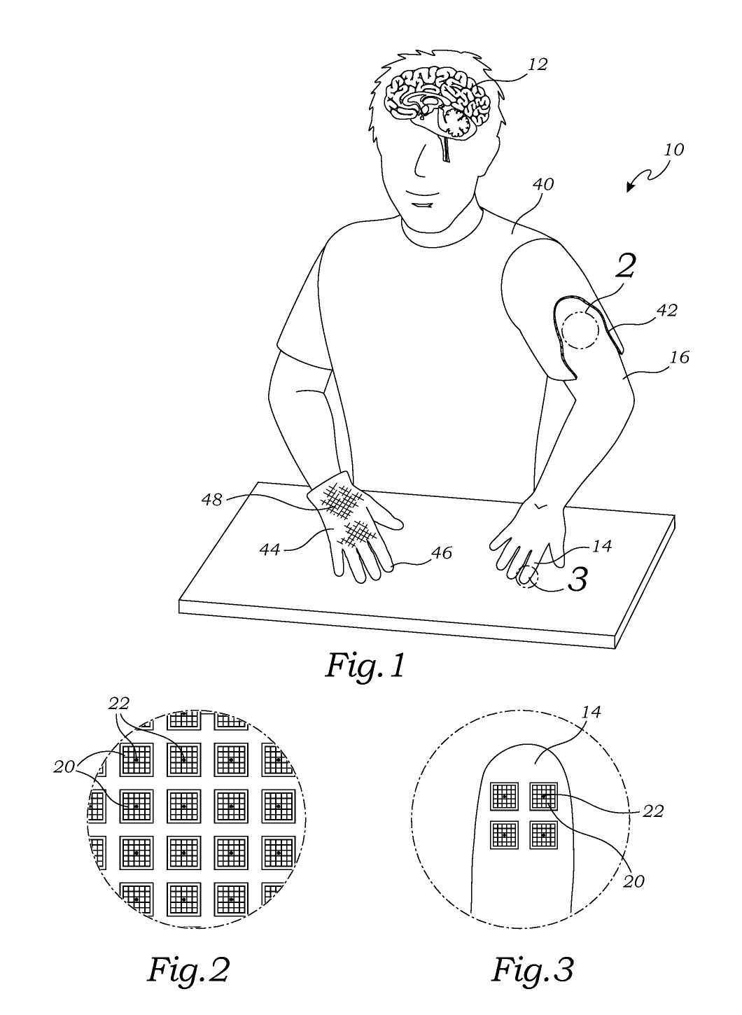

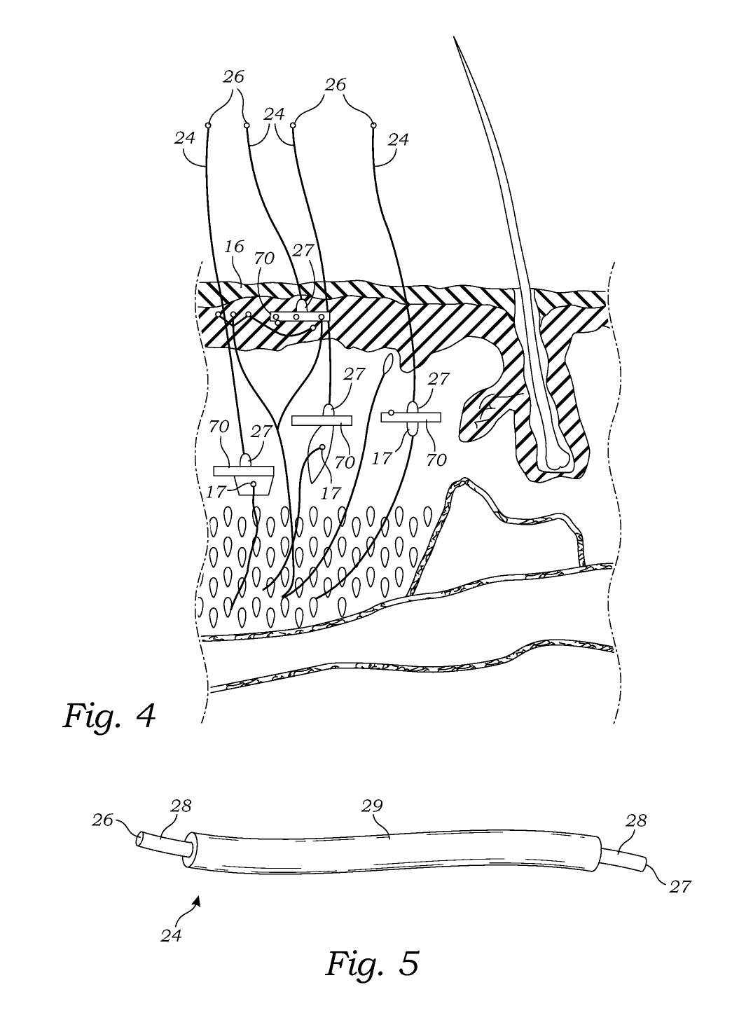

FIG. 1 is a perspective view of the user utilizing the body mind machine interface 10. In the embodiment of FIG. 1, the user is wearing a shirt 40 and a glove 44 that are adapted for use with the body mind machine interface 10. The shirt 40, the glove 44, and/or other articles of clothing or other items may unobtrusively house some components of the system as described in greater detail below. The glove 44 is well-suited for interfacing with sensors located on the hand or fingers 14, while the shirt 40 is well-suited for interfacing with the arm 16, back, or chest of the user. The implementations of the body mind machine interface 10 as shown in FIG. 1, particularly with regard to the uses of articles of clothing, are discussed in greater detail in the discussion of FIG. 4 and FIG. 5.

FIG. 2 is a close up view of a first collection of the neural interface grids 20 imprinted on the user's arm 16. FIG. 3 is a close up view of a second collection of the neural interface grids 20 imprinted on the user's finger 14. In this embodiment, the neural interface grids 20 are made of electrically conducting ink (or other suitable conducting medium) printed or otherwise implanted for conducting electrical signals from the nerves in the user's skin, originating from the brain 12. The neural interface grids 20 may also conduct electrical signals received from an external source (not shown), for providing feedback to the user.

In the embodiment of FIGS. 1-3, the neural interface grids 20 may be printed or otherwise implanted in the shape of a grid, in a dermal layer of the user, in a manner similar to a tattoo. The use of the term ‘grid’ is intended to encompass any configuration that may be found suitable by one skilled in the art, in terms of the number and orientation of the portions of electrically conducting ink. For example, the neural interface grids 20 may be in the shape of a wire mesh of varying wire diameters and grid transparencies, concentric circles with radial connections similar to a spider web, three dimensional layers, where the neural interface grids 20 are implanted one on top of the other at different depths of the user's dermal layer, a hexagonal wire pattern, etc. The ink may be of any non-toxic electrically conducting metal, such as platinum, zinc-oxide, gold, graphene, etc. While a tattoo is one method of formation, the neural interface grids 20 may be formed in any other manner known in the art, and such alternatives should be considered within the scope of the present invention. Furthermore, while we illustrate the neural interface grids 20 being formed in the user's arm 16 and the finger 14, they may be formed anywhere on the user's body that is suitable according to the teachings of the present invention.

The neural interface grids 20 intercept electrical impulses in adjacent nerve endings. The electrical impulses are received by the neural interface grids 20 and conducted to sensors of the body mind machine interface 10, as discussed below. Alternately, incoming electrical signals from an external source, transmitted through the neural interface grids 20 to a user's nerve endings, may be interpreted as sensory data. Another embodiment allows the neural interface grids 20 to act as a guard against viral infections or bacterial attacks, either through an electrostatic process of repulsion of foreign bodies, or a physical barrier, given a grid of sufficiently low transparency. In addition to use with humans, the neural interface grids 20 may be used with plants and animals, particularly animals, since their nervous system functions similarly to that of humans. Another embodiment of the neural interface grids 20 may be to replace them with biochips, that is, a computer chip that performs a similar function but is made of organic materials instead of semiconductors. Yet another embodiment may have silicon chips implanted with the neutral interface grids 20.

As shown in FIGS. 2-3, the neural interface grids 20 have an area large enough to intercept sufficient current for transmission by a transmission node 22, also embedded within the dermal layer as part of the neural interface grids 20. The transmission node 22 may be designed to conduct a received electrical signal to the sensor of the body mind machine interface 10, also as discussed below. Also, the transmission node 22 is able to receive sensor data from an external source, which is then converted to an electrical signal within the user. The characteristics of the sensor data may vary with distance and also any intervening barriers such as clothing or other materials. In the present embodiment, the grid pattern is shown to be square or rectangular shaped, but other shapes are possible such as hexagonal, circular, etc. These variations in the shape of the grid pattern are considered equivalent and within the scope of the present invention. The inclusion of multiple neural interface grids 20 increases the fidelity of the intercepted electrical signals from the brain 12, potentially allowing more complex information to be transmitted. In one embodiment, the diameter of the conducting paths defined by the implanted conducting ink may also be made small enough to be essentially ultrasensitive and invisible to the unaided eye. In another embodiment, the conducting ink may be partly or wholly comprised of colloids, with the colloids visible and electrically sensitive to signals from the user's nervous system.

As shown in FIG. 2, in one embodiment the neural interface grids 20 are implanted in the user's arm 16 (as shown in FIG. 1). In the embodiment of FIG. 3, the neural interface grids 20 are implanted in the user's finger 14. Other embodiments including the number and form of the grids of electrically conducting ink and their placement on the user's body may be determined by those skilled in the art, and these alternative embodiments are considered to be equivalent and within the scope of the present invention.

FIG. 4 is a cross-sectional view of one embodiment of the body mind machine interface 10, illustrating embedded sensors 70 connected to sheathed wires 24 for transmitting electrical signals. The embedded sensors 70 are for detecting electrical impulses transmitted along nerves in the user. The embedded sensors 70 may be bi-directional, acting as both transmitters and receivers of electrical impulses. The embedded sensors 70 may be located at nerve endings 17 or along the body of the nerves. The embedded sensors 70 may be made from doped silicone, graphene, or any other non-toxic or non-reactive material suitable for implantation in a person and reception/transmission of electrical signals. Also as shown in FIG. 4, the sheathed wires 24 have a first connection point 26 and a second connection point 27, with the sheathed wires 24 extending through the dermal layer 16 of the user. The first connection point 26 may connect to a sensor pad 32 (not shown in this figure) or other external device. The sheathed wires 24 may be connected at the second connection point 27 to one or more of the embedded sensors 70. The sheathed wires 24 may be of thin construction, similar to that of adjacent hairs. While FIG. 4 illustrates one embodiment of the embedded sensors 70 and the sheathed wires 24, those skilled in the art may devise alternative embodiments, and these alternative or equivalent are considered within the scope of the present invention.

FIG. 5 is a perspective view of one embodiment of the sheathed wires 24, illustrating an inner wire 28 surrounded by an outer layer 29. The sheathed wires 24 may be of generally coaxial construction, wherein the inner wire 28 may be a conductive material such as gold, platinum, copper, zinc, etc., for transmitting electrical signals. The outer layer 29 may be an insulator such as rubber, plastic, polytetrafluroethylene (PTFE), or other suitable insulator or material for limiting contact between the inner wire 28 of the sheathed wires 24 and the user. The outer layer 29 may serve multiple purposes, such as electrical insulation for aiding in signal transmission, or for preventing any contact between the user and the inner wire 28 in the event that the material of the inner wire 28 would have an adverse health effect on the user. In another embodiment, additional layers (not shown) may be used, and may be arranged in a coaxial manner, for example to provide a grounded shield for reducing electromagnetic pickup in the inner wire 28. In yet another embodiment, there may be multiple inner wires 28, which may have individual outer layers 29 but also surrounded by an outer layer 29 to encompass them, in the manner of common multi-conductor wiring. While FIG. 5 illustrates one embodiment of the inner wire 28 and outer layer 29 of the sheathed wires 24, those skilled in the art may devise alternative embodiments, and these alternative or equivalent are considered within the scope of the present invention.

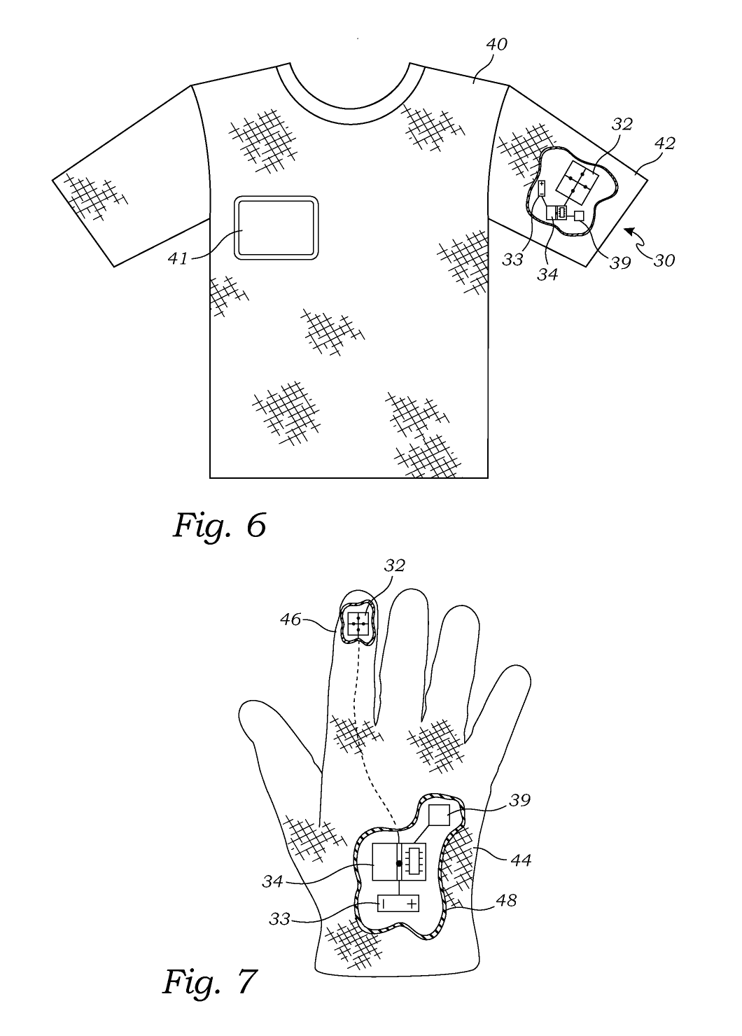

FIG. 6 is a front elevational view of the shirt 40 of FIG. 1, with a portion of the shirt 40 broken away to illustrate the sensor pad 32 integrated into the shirt 40. The sensor pad 32 may be used to detect electrical currents from the neural interface grids 20, such as via the transmission nodes 22 of the neural interface grids 20, or via other suitable structures of the neural interface grid(s) 20. As illustrated in FIG. 6, the sensor pad 32 is operably connected to an interface computer 34 and may also be used to transmit signals from the interface computer 34, or other external connection, to the neural interface grids 20. The interface computer 34 may be operably connected with a power source 33 (e.g., battery, power generation device, etc.) and an output 39. The interface computer 34 and the output 39 are discussed in greater detail below, in the discussion of FIG. 8.

As illustrated in FIG. 6, the sensor pad 32 may be an electrically conducting pad that can receive electrical current from the neural interface grid(s) 20 and conduct the current to the interface computer 34 for analysis. The shape and construction of the sensor pad(s) 32 are application dependent and designed to be appropriate to the body part that the sensor pad 32 is applied to, and to the clothing or other items that the sensor pad(s) 32 may be incorporated into. For example, in the case of clothing, the sensor pad 32 might be small and flexible so as to not interfere with the wearer or cause discomfort. The size and number of sensors in the sensor pad 32 (or sensor pads), and the specific location(s) thereof, will vary depending upon the particular determinations of those skilled in the art. It is likely that many sensor pads 32 may be used, and their correct positioning may require particular skill, and may require further structures and methods that may be determined by one skilled in the art.

In the embodiment of FIG. 6, the sensor pads 32, the interface computer 34, and the power source 33 are embedded or otherwise attached in an article of clothing, in this case the shirt 40. In this particular embodiment, they are embedded in a sleeve 42 of the shirt 40. The present embodiment takes advantage of the proximity of the sensor pads 32 to the neural interface grids 20 implanted in the user's skin as shown in FIG. 1. With the neural interface grids 20 in the user's arm 16, operatively positioning the sensor pads 32 in or on the sleeve 42, close to the neural interface grids 20, naturally strengthens the signals between the neural interface grids 20 to the sensor pads 32. The sensor pads 32, the interface computer 34, and the power source 33 may be placed in alternate locations in an article of clothing, and adjacent different parts of the user's body, and such alternatives determined by one skilled in the art is within the scope of the present invention.

As the interface computer 34 receives the current from the sensor pad 32, and determines changes in the current over time, the interface computer 34 (and/or other computing device(s)) is able to determine various forms of information. The interface computer 34 includes an interface program 37 that is able to determine feedback from the user's brain 12, and respond as determined by one skilled in the art. The interface program 37 may be able to determine, for example, the receipt of an initiation signal to start a task or project, determine a mood or feeling, or other forms of interface between the user and outside devices.

The interface program 37 is able to direct a response, based upon the data that is determined, including action that is achieved via the output 39. The output 39 may take many forms, depending upon the purpose of the body mind machine interface 10. For example, the output 39 may be a wired connection in the clothing that is operably connected to a feedback mechanism that may provide feedback to the user and/or surrounding persons, which may be in the form of visual cues (e.g., illuminated images appearing on the clothing, color changes, etc.), tactile feedback (e.g., vibration, temperature responses, etc.), audible feedback (e.g., speakers), and/or any other forms of feedback. In the present embodiment, the output 39 is operably connected to a visual display 41 that may include LEDs, illuminated threads, or similar devices for providing visual signals in response to signals from the user's brain 12.

The visual display 41 may be capable of displaying information about the user in response to the data from the sensor pad 32. For example, the body mind machine interface 10 may determine data, an emotion, etc., from the user's brainwave patterns, and then display some form of visual display (e.g., text, color(s), graphics, etc.) via the visual display 41. Items which could receive and respond to this sensor data include, but are not limited to, shirts, pants, dresses, hats, gloves or shoes. Other related applications include transmitting information about the user's physical or emotional state to external devices, such as signs or displays, that warn the user about a health or emotional condition, or a heads-up display in a vehicle to warn the user about an unacceptable intoxication level. The article of clothing or other object may be made of materials such as electrochromic polymers, which are able to change color, display words, or convey other information in a visual form, in response to the sensor data received. Other applications involving the transmission of the user's physical or emotional state and giving feedback to the user or others may be implemented by those skilled in the art and are considered equivalent and within the scope of the present invention.

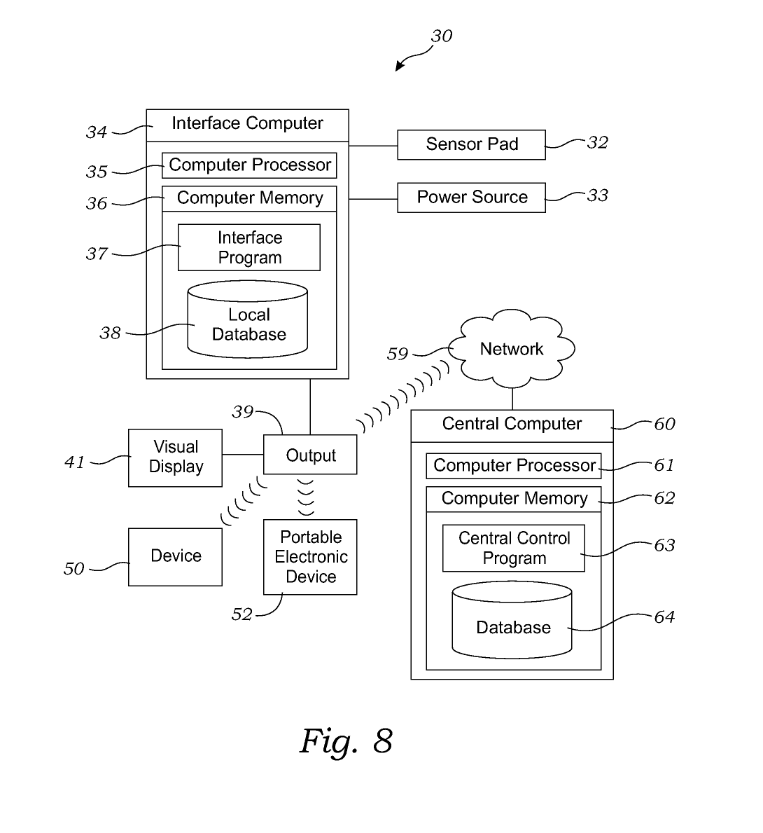

FIG. 7 is a front elevational view of the glove 44 of FIG. 1, with portions of the glove 44 broken away to illustrate another embodiment of the sensor pad 32 integrated into the glove 44. As shown in FIGS. 1 and 3, the neural interface grids 20 implanted in a user's finger 14 may be operably connected to the sensor pad 32 when the user's hand is placed within the glove 44, and the user's fingers 14 in glove fingers 46. In the present embodiment, the sensor pad 32 is operably implanted or connected to the glove finger 46. Again, having the sensor pads 32 being proximate to the neural interface grids 20 is desirable from a technical standpoint due to improved signal reception, reduced cross-talk with other sensor pads 32, etc. Due to a user using the hand and/or the fingers 14 for tasks, the interface computer 34 and the power source 33 are implanted or connected to a back portion 48 of the glove 44 (or a shoe) where they are less likely to interfere with the user or become damaged. Alternate embodiments may include having additional sensor pads 32 located on additional glove fingers 46 or in other locations throughout the glove 44. The number and placement of the sensor pads 32, the interface computers 34, and the power sources 33 within or on the glove 44 may be varied by one skilled in the art, and such variations are considered equivalent and within the scope of the present invention.

FIG. 8 is a block diagram of one embodiment of the body mind machine interface 10. As illustrated in FIG. 8, the interface computer 34 has a computer processor 35, a computer memory 36, and an interface application/program 37 operably installed in the computer memory 36. The interface computer 34 is adapted for receiving electrical currents from the sensor pad 32, and processing the currents to determine a sensor data, and/or forwarding the information to other computers for analysis.

The sensor data may be stored locally in the computer memory 36 (e.g., in a local database 38) of the interface computer 34. The interface program 37 may also convert the sensor data to a form suitable for transmission to a central computer 60, via a network 59. In this embodiment, the output 39 may include a transceiver, transmitter, or other suitable data transmitter and/or receiver. In some embodiments, the interface computer 34 may also function to convert digital data to an electrical impulse sent to the sensor pad 32 to provide feedback to the nerves of the user.

The operably connection between the interface computer 34 and the central computer 60 may be wireless or a physical connection. In the present embodiment, the output 39 is operably attached to the interface computer 34 for transmitting the sensor data from the sensor pad 32 to a central computer 60 via the network 59. While FIG. 8 illustrates one embodiment of the interface computer 34, those skilled in the art may devise alternative embodiments, and these alternative or equivalent are considered within the scope of the present invention.

The current invention envisions the development of a communication protocol using these above methods and systems.

The central computer 60 may be used for the purpose of uploading and further processing of sensor data. As illustrated in FIG. 8, the central computer 60, includes a computer processor 61, a computer memory 62, a central control program 63 installed in the computer memory 62 and a computer database 64 installed in the computer memory 62. The central control program 63 may be used to manage the flow of sensor data from an interface computer 34 and the output 39. The central control program 63 sorts and analyzes the data, through any manner of techniques known to those skilled in the art, which may include deconvolving/compiling and reconstructing the user's thoughts or other sensory data received. When the user is not actively thinking, the collected data is used as a baseline to facilitate the isolation of the user's thoughts from general sensor data. The central program 63 may separate incidental nervous system impulses encoded in the received sensor data to isolate intentional communication from the user's brain 12. Once isolated, the data may be further processed and displayed as human readable words or images. The processed data may also be stored in the database 64 of the central computer 60 for later use. An additional embodiment of the central program 63 allows it to analyze data from the neural interface grids 20 and interpret them as localized pressure measurements. The pressure measurements then can be interpreted to determine habits of the user that can be corrected to improve the user's health, such as posture, gait, etc.

The output 39 may also interact with alternative recipients, such as any form of device 50 (e.g., any form of computer, mechanical device, tool, vehicle, equipment, etc.) that one might want to direct from the brain 12. While the device 50 may be separate from the interface computer 34, they may also be the same physical structure, so that the system 10 is installed on the computer component of the device that is desired to be controlled.

In one embodiment, the output 39 may wirelessly connect with a portable electronic device 52 for transmitting data to the portable electronic device 52. The data sent to the portable electronic device 52 for display on the portable electronic device 52, or for providing some other form of feedback, or for directing the operation of the portable electronic device 52 (e.g., placing a call, entering data into the portable electronic device 52, etc.). The body mind machine interface 10 may also be used to transmit data further via the portable electronic device 52 (e.g., sending a text, placing a call, etc.).

As illustrated in FIG. 8, the power source 33 is used to power the interface computer 34. The power source 33 may be of any type that is capable of powering the interface computer 34 during normal use, including batteries, piezoelectrics, photovoltaics, a wired connected to a power grid, etc. In a standard construction, the power source 33 is a battery. In another example, a device which converted walking or other motion into electrical current for powering the interface computer 34 may be utilized.

As used in this application, the terms computer, processor, memory, and other computer related components, are hereby expressly defined to include any arrangement of computer(s), processor(s), memory device or devices, and/or computer components, either as a single unit or operably connected and/or networked across multiple computers (or distributed computer components), to perform the functions described herein.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A body mind machine interface for receiving direction from a brain of a user, the body mind machine interface comprising:
a neural interface grid operably printed or implanted in or on the user for conducting electrical currents;
a sensor pad for sending or receiving the conducted electrical currents to or from the neural interface grid when the sensor pad is positioned proximate to the neural interface grid, and generating an electrical signal;
an interface computer operably connected to the sensor pad for receiving the electrical signal from the sensor pad, the interface computer having a computer processor and a computer memory; and
an interface program operably installed on the computer memory of the interface computer for processing the electrical signal from the sensor pad and determining the direction from the brain.

2. The body mind machine interface of claim 1, further comprising a central computer operably connected to the interface computer, the central computer having a computer processor, computer memory, and a central program operably installed in the computer memory for receiving the electrical signal from the interface computer, and determining the direction of the brain.

3. The body mind machine interface of claim 1, further comprising an output for transmitting the direction from the brain.

4. The body mind machine interface of claim 3, further comprising a device for receiving the direction via the output, and responding to the direction.

5. The body mind machine interface of claim 3, further comprising a portable electronic device for receiving the direction via the output, and responding to the direction.

6. The body mind machine interface of claim 3, further comprising a visual display that changes in response to the direction.

7. The body mind machine interface of claim 1, wherein the sensor pad, the interface computer, and a power source are operably embedded within an article of clothing.

8. The body mind machine interface of claim 1, further comprising sheathed wires having a first connection point, a second connection point, an inner wire, and an outer layer.

9. The body mind machine interface of claim 8, further comprising one or more embedded sensors operably embedded in the body of the user for sensing electrical impulses of adjacent nerves.

10. The body mind machine interface of claim 9, wherein the sheathed wires are operably connected to the sensor pad at the first connection point and the sheathed wires are operably connected to the embedded sensors at the second connection point.

11. The body mind machine interface of claim 8, wherein the inner wire is a conductor and the outer layer is an insulator.

12. A method for providing an output in response to a direction from a brain of a user, the method comprising the steps of:
implanting a neural interface grid into a dermal layer of the user, the neural interface grid being conductive of electrical currents from the user's nervous system, generated by the brain or nerves;
positioning a sensor pad on the dermal layer of the user proximate to the neural interface grid for sending or receiving electrical currents to or from the neural interface grids, and generating a electrical signal;
operably connecting an interface computer to the sensor pad, the interface computer having a computer processor, a computer memory; and
performing signal analysis to convert the electronic signal received by the interface computer to determine the direction from the brain.

13. The method of claim 12, further comprising the step of processing the electrical signal using the following operations:
i) determining a baseline or background waveform representing ambient or external stimuli not related to active communication;
ii) removing the baseline or background waveform from the electrical signal leaving only a communication waveform related to active communication; and
iii) converting the communication waveform into processed data.

14. The method of claim 12, wherein the neural interface grid is an implanted conducting ink.

15. The method of claim 14, wherein the diameter of the implanted conducting ink is smaller than what is detectable by the unaided eye.

16. The method of claim 14, wherein the conducting ink comprises platinum, gold, and/or graphene.

17. The method of claim 14, wherein the conducting ink is non-toxic to humans.

18. The method of claim 12, wherein the conducting ink is implanted into areas of the user with high nerve density.

19. The method of claim 12, wherein the neural interface grid includes an implanted biochip or an implanted silicon chip.

20. A method for providing an output in response to a direction from a brain of a user, the method comprising the steps of:
implanting a neural interface grid into a dermal layer of the user, the neural interface grid being conductive of electrical currents from the use's brain;
positioning a sensor pad on the dermal layer of the user proximate to the neural interface grid for receiving the electrical currents from the neural interface grids, and generating a electrical signal;
operably connecting an interface computer to the sensor pad, the interface computer having a computer processor, a computer memory; and
providing a central computer operably connected to the interface computer, the central computer having a computer processor, a central computer memory;
transmitting the electronic signal from the interface computer to the central computer; and
performing signal analysis via the central computer to convert the electronic signal received by the interface computer to determine the direction from the brain.
